(19) United States
(12) Patent Application Publication
(10) Pub. No.: US 2006/0159350 A1
(43) Pub. Date: Jul. 20, 2006

(54) Apparatus and method for image processing

(75) Inventor: Hiroyuki Watanabe, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/331,235

(22) Filed: Jan. 13, 2006

(30) Foreign Application Priority Data
Jan. 17, 2005 (JP) 2005-009657

(51) Int. Cl. G06K 9/36; G06K 9/32

(52) U.S. Cl. 382/232; 382/297

(57) ABSTRACT

An image processing apparatus includes an entropy decoding section, an extracting section, a reconfiguring section, and an entropy encoding section. The entropy decoding section carries out entropy-decoding on each of blocks of an image data supplied thereto to generate entropy-decoded blocks. The extracting section extracts original block data of the entropy-decoded blocks. The reconfiguring section relates the original block data of the entropy-decoded blocks one after another based on a reconfiguration setting data to rearrange the entropy-decoded blocks. The entropy encoding section carries out entropy-encoding to the entropy-decoded blocks to produce a new image data.

### BACKGROUND OF THE INVENTION

1. Field of the Invention

The present invention relates to an apparatus and method for image processing.

2. Description of the Related Art

When a photographic image is taken with a digital camera and is then transferred to and printed by a printer, it is not necessarily appropriate to print the photographic image on photographic paper in a state which the horizontal direction of the photographic image is coincident with a width direction of photographic paper. There is a case that it is better to set a vertical direction of the photographic image to the width direction of the photographic paper. In this case, the photographic paper can be utilized to a maximum extent for printing, because it is possible to print the image in a larger size. For example, when the photographic image taken with the digital camera in a landscape mode (horizontally long mode) is as shown in FIG. 13A, it is better to rotate the image by 90 degrees and to print the image with the shorter side of the image as a horizontal side, as shown in FIG. 13B, rather than to print the image as it is. That is to say, the direction of the original photographic image taken with the digital camera is not necessarily identical to a desired print direction.

By the way, in image compression algorithm such as JPEG (Joint Photographic Experts Group), blocks of a compressed image are usually expanded in the order of the compression. In other words, each block of the image is converted into a DC component and an AC component as data in a frequency space through DCT conversion, and the DC component and the AC component are compressed through quantization and further compressed by use of Huffman encoding. Thus, a compression rate of the JPEG image can be increased. When the DC component is compressed through the Huffman encoding, a difference in the DC component between a current block of the image and an immediately preceding block of the image is used instead of an absolute value of the DC component. For this reason, it is necessary to expand the blocks of the image data in the block compression order.

From the above reason, when image processing such as a rotation of an image is carried out to change the block compression order, a method disclosed in Japanese Laid Open Patent Application (JP-A-Heisei 10-70735) has conventionally been used. In this conventional method, blocks of a compressed image data are all expanded to obtain a final image and then the image processing such as rotation and clipping is carried out. In other words, it is necessary to expand the blocks of the compressed image data once for each frame, and then generate the compressed image data in which the blocks are rearranged in a desirable order. At this time, a memory is required for temporarily storing the expanded image data for the frame.

As described above, a memory of a large capacity is generally necessary to conduct the image processing. Therefore, either the digital camera or the printer has to be provided with a memory of the large capacity enough to carry out the image processing. On the other hand, in low-priced digital camera and printer, a memory of such a large capacity cannot be installed, because of a low price, small size, and low power consumption.

Japanese Laid Open Patent Application (JP-A-Heisei 10-70735) discloses a technique to reduce a size of a memory used for image processing in a digital still camera. In this conventional example, the digital still camera is provided with an image sensor, an A/D converter, an image processing section, an image memory, and an image expanding section. The image sensor outputs an image sensor signal of an image, and the A/D converter converts the image sensor signal into a digital signal. The image processing section compresses the digital signal from the A/D converter, and outputs a compressed image data. The image memory stores the compressed image data. The image expanding section expands the compressed image data in the image memory. In a digital camera, a storage operation and a vertical read operation are carried out in order for every kind of component data. The storage operation is an operation of storing in a first memory, only one of a plurality of kinds of component data forming a color image signal obtained from the output of the image expanding section. The vertical read operation is an operation of scanning the component data in the first memory in a vertical direction to read the scanned component data, after the storage operation for one frame is completed. Thus, the capacity of the memory used for the image processing can be reduced by storing data of only one of three components. However, data for one frame has to be stored even for processing of a single component of each pixel.

Also, Japanese Laid Open Patent Application (JP-A-Heisei 11-4434) discloses a data expanding method of carrying out an expanding process of a plurality of blocks of a compressed image data in a vertical direction. In this conventional data expanding method, firstly a work memory is prepared to have a capacity equivalent to a vertical column of blocks. Subsequently, a predetermined process is carried out to each horizontal row of blocks, and a first parameter relevant to a first vertical column of blocks is sensed. After that, the expanding process is carried out on the first vertical column of blocks by using the work memory and the first parameter. In the expanding process, a second parameter relevant to a second vertical column of blocks is sensed. Thus, expansion is carried out in a direction different from a compression direction. In this conventional method, a special kind of a structure is required for the expansion of the compressed image data but such a special structure is not prepared in a general expanding unit. Therefore, when the compressed image data is transferred to a apparatus having a general expanding unit, an amount of data to be transferred increases since the data to be transferred is the expanded data, although transferring of the data in processing order is possible.

Also, Japanese Laid Open Patent Application (JP-A-Heisei 10-276403) discloses an image processing technique related to a digital imaging apparatus. After conversion of an incident optical image into an image data, the digital imaging apparatus carries out an image compressing process to each of blocks of the image data with a predetermined size, and records the compressed blocks of the image data. The digital imaging apparatus is provided with an imaging section, a first storage section, an image compressing section, and a record medium. The imaging section images the incident optical image of an area of a rectangular shape, and converts the imaged optical image into a digital signal. The first storage section stores the digital signal of the image in an array of blocks for a rectangular shape corresponding to the optical image. The image compressing section reads out the blocks from the first storage section in order in a direction of the short side of the rectangular shape, applies conversion of rotation by 90 degrees with respect to a predetermined direction to the read-out blocks, and carries out an image compressing process on the converted blocks. The compressed blocks outputted from the image compressing section are stored in the storage medium stores. In this conventional example, the image is rotated to change the direction of the image.

Further, Japanese Laid Open Patent Application (JP-P2000-134459A) discloses an image processing method of rotating an image in a frequency space by using frequency conversion, without converting a compressed image into an image in a real-space. The image is compressed by using the frequency conversion through discrete cosine transform. Thus, the image is rotated by changing a zigzag table in a frequency space or inverting a code of an alternating component of the data.

As described above, conventionally, when image processing such as rotation of an image is carried out to a change an image compression order, it is necessary to expand a compressed image data for one frame once, and subsequently generate an compressed image data in which blocks are rearranged in a desirable order. Consequently, a memory of a large capacity is required to carry out the image processing.

### SUMMARY OF THE INVENTION

In an aspect of the present invention, an image processing apparatus includes an entropy decoding section, an extracting section, a reconfiguring section, and an entropy encoding section. The entropy decoding section carries out entropy-decoding on each of blocks of an image data supplied thereto to generate entropy-decoded blocks. The extracting section extracts original block data of the entropy-decoded blocks. The reconfiguring section relates the original block data of the entropy-decoded blocks one after another based on a reconfiguration setting data to rearrange the entropy-decoded blocks. The entropy encoding section carries out entropy-encoding to the entropy-decoded.

Here, the image data is a JPEG data generated by converting an image into the image data in a frequency space in units of blocks, each of which has a plurality of pixels of the image in matrix, and carrying the entropy-encoding on the image data in unit of the blocks. In this case, the image data may be further quantized.

Also, the blocks are preferably grouped into a plurality of block linkages, and the reconfiguring section rearranges the entropy-decoded blocks in units of block linkages. In this case, the number of the blocks may be constant over the plurality of block linkages, or each of the plurality of block linkages may contain the blocks of an optional number.

The image processing apparatus may further include a reconfiguration setting data generating section configured to generate the reconfiguration setting data based on a predetermined region. In this case, the entropy-encoded blocks are outputted in order based on the reconfiguration setting data.

Also, the extracting section may extract the original block data of the entropy-decoded blocks and an address of a head block of each of the plurality of block linkages based on the reconfiguration setting data to produce a configuration data. In this case, the reconfiguring section may read out the blocks in order based on the reconfiguration setting data to entropy-decoding the blocks, relate the original block data of the entropy-decoded blocks based on the configuration data and the reconfiguration setting data to rearrange the entropy-decoded blocks.

In another aspect of the present invention, a method of image processing is achieved by extracting an original block data from each of blocks of an image data, wherein the original block data of the blocks which are entropy-decoded are related to one after another in an arrangement order of the blocks; by rearranging the blocks in a rearrangement order defined based on the reconfiguration setting data by relating the original block data of the blocks, which are entropy-decoded, one after another by using the original block data; and by entropy-encoding the blocks which are entropy-decoded, for a new image data.

Here, the blocks of the image data are preferably grouped into a plurality of block linkages while the original arrangement order is kept in each of the plurality of block linkages, and the reconfiguration setting data contains the rearrangement order in units of block linkages and has a data indicating a head block of each of the plurality of block linkages.

Also, the extracting may be achieved by entropy-decoding the blocks in the arrangement order; by determining the original block data of the entropy-decoded blocks from a related block data of each of the entropy-decoded blocks and the original block data of a previous entropy-decoded block; and by holding the original block data of the head blocks based on the reconfiguration setting data.

Also, the number of the blocks may be constant over the plurality of block linkages, or each of the plurality of block linkages may contain the blocks of an optional number.

Also, the method may be achieved by further generating said reconfiguration setting data based on designation of a predetermined region.

The entropy-encoded blocks may be outputted in the rearrangement order based on the reconfiguration setting data.

Also, when the plurality of block linkages are grouped into groups, and the extracting is carried out to a first one of the groups, the rearranging may be achieved by entropy-decoding the blocks in the rearrangement order. The method may be achieved by further extracting the original block data of the head blocks of the block linkages in a next one of the group.

Also, the rearranging may be achieved by entropy-decoding the blocks in the rearrangement order; and by determining a new related block data of each of the head blocks from the original block data of the head block and the original block data of a previous block.

Also, the blocks are stored in a memory, and the block is a variable length data. The method may be achieved by extracting an address of each of the head blocks in addition to the original block data thereof. The method may be achieved by further storing the entropy-encoded head block in the memory based on the address.

### BRIEF DESCRIPTION OF THE DRAWINGS

FIG. 1 is a block diagram showing a configuration of an image processing apparatus according to a first embodiment of the present invention;

FIG. 2A is a diagram schematically showing an array of blocks of a compressed image data;

FIG. 2B is a diagram showing the blocks linked in units of three blocks;

FIG. 3 is a flow chart showing an operation of extracting configuration data from the blocks of the compressed image data based on the reconfiguration setting data in the first embodiment of the present invention;

FIG. 4 is a diagram showing a reconfiguration setting data;

FIG. 5 is a diagram showing configuration data (original block data) in a rearrangement order;

FIG. 6 is a flow chart showing a process of recompressing an image data;

FIG. 7A is a diagram showing an arrangement order of blocks of the compressed image data, and FIG. 7B is a diagram showing a table indicating the contents of the blocks;

FIGS. 8A and 8B show a data stream and a conceptual table of a stream data after the rearrangement;

FIG. 9 is a flow chart showing an operation to extract configuration data in a second embodiment of the present invention;

FIG. 10 is a diagram showing the reconfiguration setting data used in the second embodiment of the present invention;

FIGS. 11A to 11C are diagrams showing the configuration data;

FIG. 12 is a flow chart showing a process of recompressing the image data in the second embodiment of the present invention;

FIG. 13A shows a photographic image taken with a camera in a landscape mode, and FIG. 13B shows a rotated photographic image;

FIG. 14 is a diagram showing the reconfiguration setting data used in a third embodiment; and

FIGS. 15A to 15C are diagrams showing states of an array of blocks of the image data.

### DESCRIPTION OF THE PREFERRED EMBODIMENTS

Hereinafter, an image processing apparatus of the present invention will be described in detail with reference to the attached drawings.

### First Embodiment

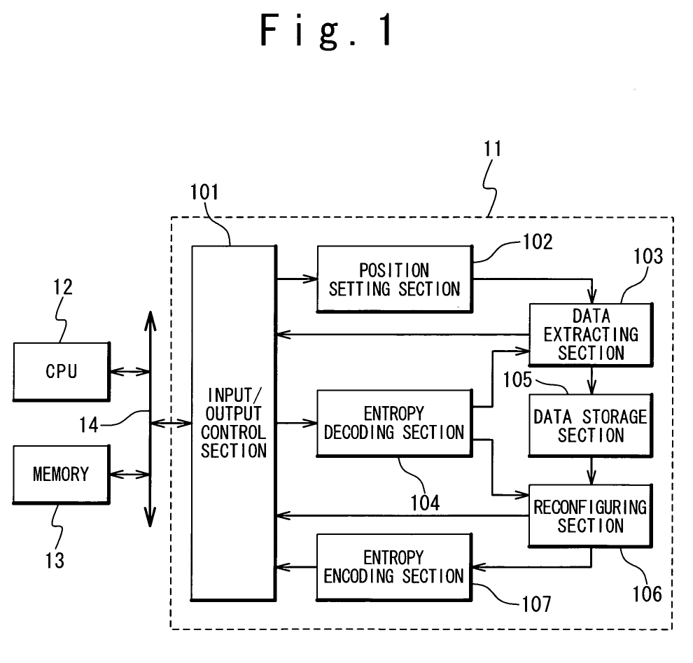

FIG. 1 is a block diagram showing a configuration of an image processing apparatus such as a digital still camera according to the first embodiment of the present invention. The image processing apparatus has an image compressing unit 11, a CPU (central processing unit) 12, and a memory 13, which are connected through a data bus 14. The image compressing unit 11 has an input and output control section 101, a position setting section 102, a data extracting section 103, an entropy decoding section 104, a data storage section 105, a reconfiguring section 106, and an entropy encoding section 107. Data and operation instructions are inputted to the image compressing unit 11 from the memory 13 through the data bus 14 by a DMA (Direct Memory Access) section (not shown) or by the CPU 12, or rearranged or compressed image data is outputted from the image compressing unit 11 to the memory 13.

The input and output control section 101 transmits a data supplied to the image compressing unit 11, to each functional block in accordance with a use purpose, and outputs the data received from each of the functional blocks to the CPU 12 or the memory 13. The position setting section 102 stores or holds a reconfiguration setting data such as image rearrangement order and a block position instructed by the CPU 12, and supplies the reconfiguration setting data to the data extracting section 103. The data extracting section 103 extracts configuration data from blocks of an image data in a frequency space based on the reconfiguration setting data from the position setting section 102, and outputs the extracted configuration data to the data storage section 105. The data storage section 105 stores the configuration data extracted by the data extracting section 103, and supplies the stored configuration data in accordance with a request from the reconfiguring section 106. The entropy decoding section 104 decodes the blocks of the compressed image data read out from the memory 13 into the blocks of the image data in the frequency space. Then, the entropy decoding section 104 supplies the decoded blocks of the image data in the frequency space to the data extracting section 103 or the reconfiguring section 106. The reconfiguring section 106 reconfigures the decoded blocks of the image data in the frequency space based on the configuration data read out from the data storage section 106 and the reconfiguration setting data. The entropy encoding section 107 carries out entropy encoding on the reconfigured blocks of the image data in the frequency space to generate a new compressed image data, and stores the encoded or compressed image data in the memory 13 through the input and output control section 101.

A photographic image data taken in a landscape mode (horizontally long) is stored in the memory 13. The photographic image data is compressed by applying so-called DCT transform to each block of 8×8 pixels, and the compressed photographic image data is stored in a JPEG format. That is, each block of the compressed image data is stored as a variable-length data.

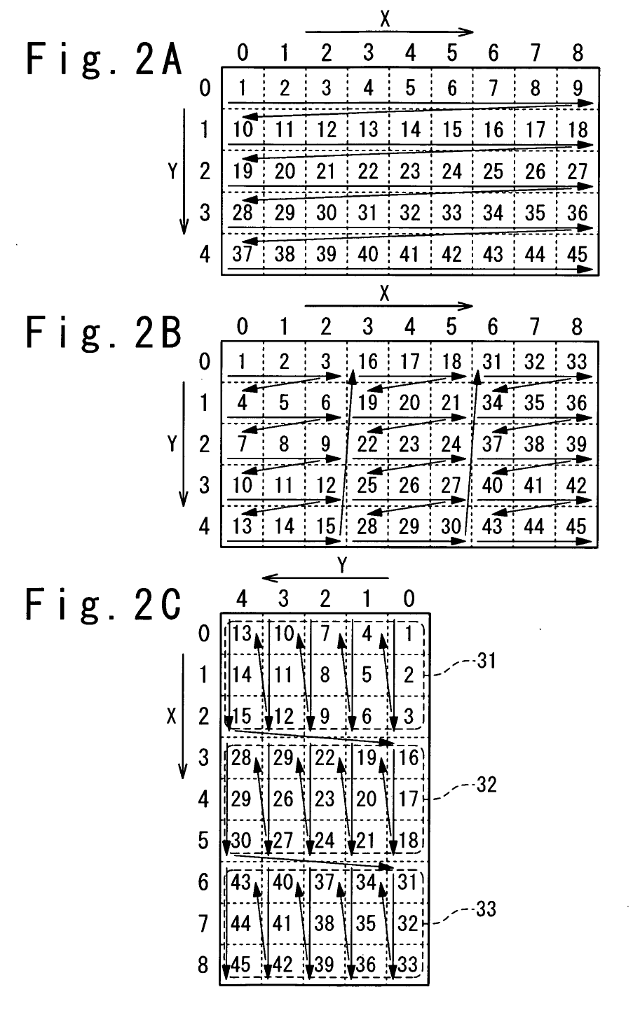

FIG. 2A is a diagram schematically showing an array of blocks (each block having 8×8 pixels) of the compressed image data (72×40 pixels), for example. The compressed image data can be expressed in a two-dimensional array of nine blocks in a horizontal direction (X) and five blocks in a vertical direction (Y). As shown by arrows in FIG. 2A, the blocks of the compressed image data are arranged in the horizontal direction while being arranged in the vertical direction. In other words, the blocks of the compressed image data are one-dimensionally stored as a JPEG data stream in the memory 13 in the order of numerals shown in FIG. 2A.

A method of reconfiguring the block of the compressed image data in response to an instruction from the CPU 12 includes processes: a receiving process of the reconfiguration setting data indicating a rearrangement order received from the CPU 12, an extracting process of the configuration data from the blocks of the compressed image data based on the reconfiguration setting data, and a reconfiguring process of reconfiguring the blocks of the compressed image data based on the extracted configuration data and the reconfiguration setting data.

An operation of the image processing apparatus in the process of extracting the configuration data from the blocks of the compressed image data will be firstly described. FIG. 2A shows a compression order of an original compressed image data. As shown by the arrows in FIG. 2A, the blocks of the original compressed image data are subjected to the DCT transform and the quantization in units of blocks in order from block 1 at an upper left corner, and then the entropy encoding is carried out in the horizontal direction. Here, a group of blocks arranged in the horizontal direction, e.g. blocks 0 to 9 is referred to as a horizontal block linkage. A head block of each horizontal block linkage is encoded consecutively from the last block of a previous horizontal block linkage, and then the remaining blocks of the horizontal block linkage are encoded consecutively.

The adjacent blocks of the compressed image data generally are related to each other, and the relation appears on a DC value as a DC component. In the JPEG encoding method, a DC value of one block is expressed based on a difference in the DC value between a current block and a previous block, in order to improve efficiency of the entropy encoding. For this reason, the blocks of the compressed image data are closely combined. Thus, an arrangement order of the blocks is a kind of data as well.

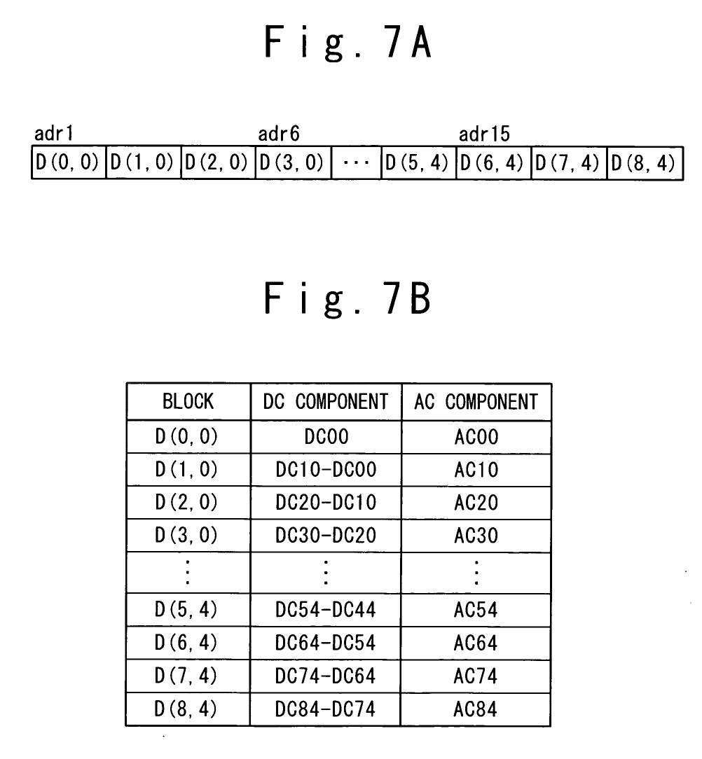

FIG. 7A shows the arrangement order of the blocks of the compressed image data, and FIG. 7B shows a table indicating the contents of the blocks. In FIG. 7A, a data of a block positioned on coordinates (X, Y) in FIG. 2 is expressed as D(X, Y). In FIG. 7B, a DC component or a DC value of the block (X, Y) is expressed as DCXY, and an AC component or an AC value thereof is expressed as ACXY. The original compressed image data starts from a block (0, 0), as stated above. The block (0, 0) has a data D(0, 0) which has DC00 as a DC value and AC00 as an AC value. An address of the block (0, 0) in the memory 13 is adr1. A block (1, 0) adjacent to the block (0, 0) in the horizontal direction has a data D(1, 0) which has a differential DC value (DC10-DC00) and AC10. This differential DC value is obtained by subtracting the DC value DC00 of the block (0, 0) from DC10 as the DC value of the block (1, 0). Subsequently, the blocks (2, 0), (3, 0), and the like are arranged, and the block (8, 0) is the last block in this block linkage. The block (8, 0) has a data D(8, 9) which has a differential DC value (DC80-DC70) and an AC value AC80. A block (0, 1) in a block linkage under this block linkage follows the block (8, 0). Therefore, the block (0, 1) has (DC01-DC80) as a differential DC value of a data D(0, 1). An AC value of the data D(0, 1) is AC01. The blocks follow in the same way as described above, and the last block (8, 4) of the array of the blocks has a data D(8, 4) which has a differential DC value (DC84-DC74) and an AC value AC84.

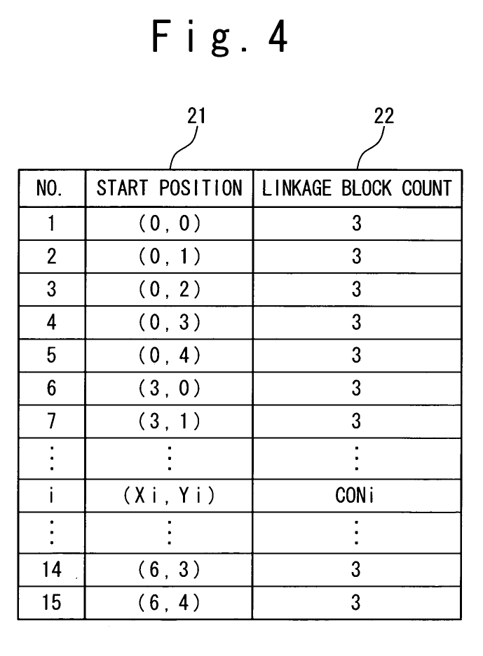

For the blocks arranged as described above, the reconfiguration setting data shown in FIG. 4 is instructed from the CPU 12. The position setting section 102 receives and holds the reconfiguration setting data which includes a rearrangement start position 21 as a position of the head block in each block linkage and a linkage block count 22 as the number of blocks in the block linkage in a horizontal direction from the rearrangement start position 21. Here, a coordinate origin is an upper left block in an array of blocks of an image data for a frame as shown in FIG. 2A. That is, the coordinates at the origin are (0, 0), and coordinates in both the X and Y directions are expressed as the number of blocks. In case of an i^{th} rearrangement position, the rearrangement start position is (Xi, Yi), and the linkage block count is CONi.

The coordinates of the head block of each block linkage with respect to the origin are set in the rearrangement start position 21. In FIG. 4, the block width of each block linkage is a constant, and a value “3” is uniformly set as the linkage block count (CONi). Only the linkage block count may be changed. It is also possible to set different values as the linkage block counts for the block linkages. Thus, the compression (rearrangement) order can be freely set for an image to be ultimately obtained based on the rearrangement start positions and the linkage block counts. If the linkage block counts CONi are all set to “3” as shown in FIG. 4, the blocks are linked in units of three blocks in the horizontal direction, the compression order can be changed, as shown in FIG. 2B. By providing the reconfiguration setting data, the compression order can be freely set for the image to be obtained ultimately based on the rearrangement start position and the linkage block count. In this case, when the same value is set for all the linkage block counts, it is not necessary to set the rearrangement start position and the linkage block count in pairs. It is sufficient to set only the rearrangement start positions in order. Thus, a required memory capacity is further reduced.

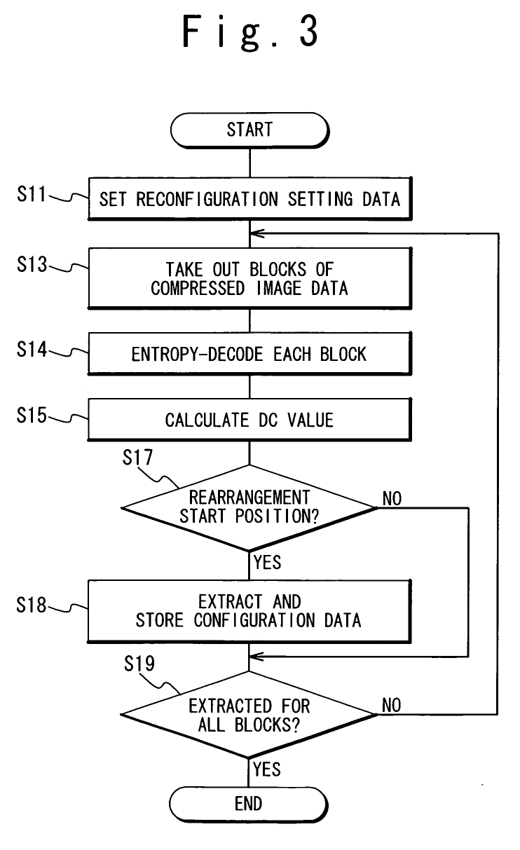

FIG. 3 is a flow chart showing an operation of extracting the configuration data from the blocks of the compressed image data based on the reconfiguration setting data held in the position setting section 102. As stated above, the rearrangement start positions and the linkage block counts are set in the position setting section 102 (Step S11).

The image compressing unit 11 sequentially takes out or reads out the blocks of the compressed image data from the memory 13 in units of blocks in the order shown in FIG. 2A (Step S13). The blocks of the compressed image data stored in the memory 13 are variable-length data, since the entropy encoding has been carried out on them. The entropy decoding section 104 carries out the entropy decoding on each block of a variable-length. Consequently, each block of the compressed image data is decoded into a block of an image data in a frequency space (Step S14).

The entropy-decoded block of the image data in the frequency space is sent to the data extracting section 103. The block data D(X, Y) of a currently processed block (X, Y) of the image data in the frequency space is then separated into the DC component or a DC value and the AC component or an AC value, as shown in FIG. 7B. The DC component is expressed as a difference between a DC value of the currently processed block and a DC value of a previously processed block processed immediately before the currently processed block. Therefore, the DC value of the currently processed block is calculated based on the above differential DC value and the DC value of the previously processed block. At this time, the DC value of the previously processed block is held in the data extracting section 103. Since the DC component of the currently processed block is a differential DC value, the DC value of the currently processed block is obtained by adding the DC value of the previous processed block held in the data extracting section 103 to the differential DC value of the currently processed block. The obtained DC value is held in the data extracting section 103 as a new DC value for the next block. It should be noted that an initial value of the held DC value is “0”. In the processing of the block data D(0, 0) of the origin block (0, 0), uniformity of the processing can be obtained by considering DC00-0. Thus, the data extracting section 103 calculates the DC value of each block and holds the calculated DC value (Step S15).

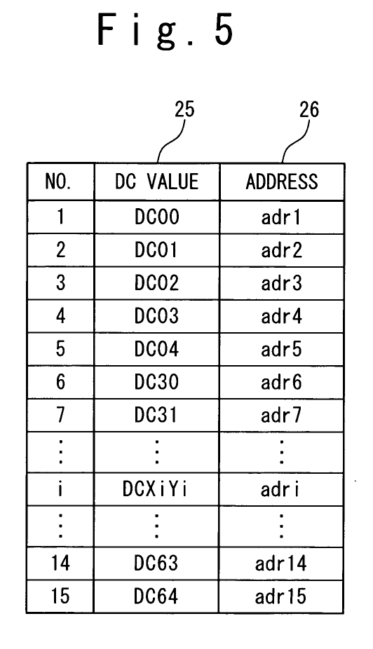

Next, it is determined whether or not the currently processed block is specified as the block of the rearrangement start position in the position setting section 102 (Step S17). If the currently processed block is not in the rearrangement start position (Step S17—NO), the control flow advances to a next step S19. When the currently processed block is in the rearrangement start position (Step S17—YES), the configuration data necessary for the rearrangement of the currently processed block of the image data is extracted by the data extracting section 103. The data necessary for the rearrangement of the currently processed block is an address of the currently processed block in the memory 13 in addition to the DC value of the currently processed block. Since the blocks of the compressed image data are the variable-length data, the address may indicate a byte (word) position or a bit position. The DC value and the address are outputted to the data storage section 105, and are stored therein. As shown in FIG. 5, the data storage section 105 stores the DC value 25 and the address 26 in accordance with the rearrangement order (Step S18).

Next, a determination is made of whether or not the blocks in the rearrangement start positions is all extracted (Step S19), and the above process is repeated from the Step S13 until all the blocks are extracted. If all the data are extracted (Step S19—YES), the data extracting operation is completed.

Here, it is supposed that where the compressed image data shown in FIG. 2A is inputted in units of blocks, and the inputted blocks of the compressed image data are rearranged as shown in FIG. 2B. In this case, the first block of the compressed image data is read out to calculate the DC value. A DC value DC00 is calculated from the differential DC value DC00 of the block (0, 0) shown in FIG. 7B and the initial value “0” of the held DC value. The calculated DC value DC00 is held as a new DC value by the data extracting section 105. The block is in the rearrangement start position of the rearrangement order 1 shown in FIG. 4. Therefore, the DC value DC00 and the address adr1 of the memory 13 are stored in the data storage section 105, as shown as the rearrangement order 1 in FIG. 5. The block data D(1, 0) to be inputted next has a differential DC value (DC10-DC00). The DC value DC10 of the block (1, 0) is calculated by adding the held DC value DC00 to the differential DC value (DC10-DC00), and the calculated DC10 is held as the new DC value. Since the block (1, 0) is not a block of the rearrangement start position, the control advances to the next block (2, 0). In the processing of the block (3, 0), the DC value DC30 is calculated as described above, and it is found that the block (3, 0) is in the rearrangement start position of the rearrangement order 6, as a result of determination of the rearrangement start position. Therefore, the data storage section 105 stores the DC value DC30 and an address adr6 in the position of the rearrangement order 6. In this way, the image compressing unit 11 sequentially reads out the blocks of the compressed image data from the memory 13, and extracts the configuration data for storage in the data storage section 105.

If the extracting process is completed, the DC values and the addresses of the blocks in the rearrangement start positions are extracted from the JPEG data stream shown in FIG. 7A, and the configuration data is stored in accordance with the rearrangement order as shown in FIG. 5.

In this way, by extracting the DC values and the addresses of the rearrangement start positions, the processing is possible in a far less memory capacity, as compared with a case of a method of once decoding the compressed image data in an image data in an actual space for the reconfiguration. In this case, the configuration data may be stored in the memory 13, although it has been described here that the configuration data is stored in the data storage section 105.

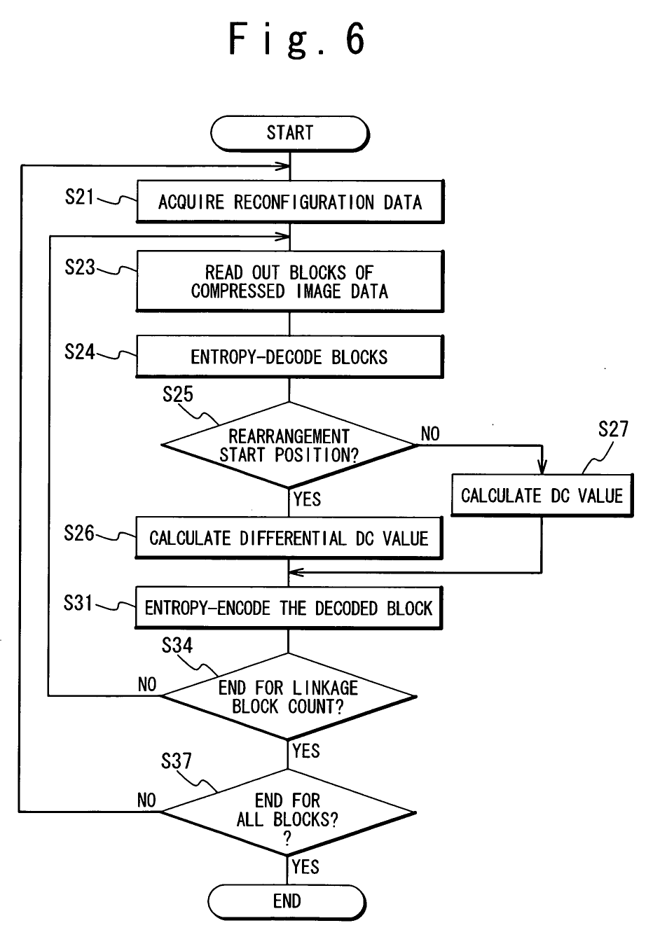

Next, a recompressing process of the image data is carried out based on the configuration data extracted in the extracting process and the reconfiguration setting data. FIG. 6 is a flow chart showing the recompressing process of the image data in the frequency space. The DC value to be held is cleared as an initial setting process not shown.

First, the reconfiguring section 106 obtains the configuration data stored as shown in FIG. 5 from the data storage section 105 in the rearrangement order (Step S21).

The reconfiguring section 106 instructs the block to be read out from the memory 13 through the input and output control section 101 based on the reconfiguration setting data (Step S23). At this time, the blocks are read out from the block (0, 0). The read out block is entropy-decoded into the image data block in the frequency space by the entropy decoding section 104, and the decoded image data block is outputted to the reconfiguring section 106 (Step S24). The reconfiguring section 106 determines whether or not a currently processed block is a block in the rearrangement start position (Step S25).

If the currently processed block is a block in the rearrangement start position (Step S25—YES), the configuration data stored in the data storage section 105 is referred to and the DC value of the currently processed block is read out. Then, a new differential DC value after the reconfiguration is calculated based on the read-out DC value 25 and a DC value held for a previous block linkage (Step S26). Then, the control advances to a step S31. If the decoded block is not a block in the rearrangement start position (Step S25—NO), the currently processed block is a block to be linked, and the differential DC value can be used without change. For calculation of the differential DC value of the next block after the reconfiguration, the DC value of the currently processed block is calculated based on the differential DC value and the held DC value, and the calculated DC value is held as a new held DC value for the current or next block linkage (Step S27).

When the new differential DC value of the currently processed block is calculated, the entropy encoding section 107 carries out the entropy encoding on the currently processed block in continuation from the previously processed block of the image data in the frequency space. The encoded block of the image data is outputted to the memory 13 through the input and output control section based on the address obtained from the configuration data and stored therein (Step S31). Also, when the currently processed block is not in the rearrangement start position, the differential Dc value needs not to be recalculated, and the currently processed block is subjected to the entropy-encoding. The encoded block of the image data is outputted to the memory 13 through the input and output control section and stored therein subsequently to the previously processed block (Step S31).

Steps S23 to S31 are repeated for the linkage block count defined in the reconfiguration setting data (Step S34—NO). If the processing is completed for the number of blocks shown by the linkage block count CONi (Step S34—YES), the DC value is held in the data storage section 105 for a subsequent block linkage. Then, it is determined whether or not the recompression of all the blocks is completed (Step S37). If any block to be recompressed is left (Step S37—NO), the process is repeated back from the Step S21. If the recompression of all the blocks is completed (Step S37—YES), the recompressing process is ended.

For example, it is supposed that the configuration data is set as shown in FIG. 5, and the compressed image data is rearranged and recompressed as shown in FIGS. 7A and 7B based on the reconfiguration setting data. If the recompressing process is started, the held DC value is set to “0”. The blocks are sequentially read out in units of three blocks based on the reconfiguration setting data. The DC value DC00 and the address adr1 in the rearrangement order 1 of the configuration data are read out by the reconfiguring section 106 as shown in FIG. 5. Each block of the compressed image data in the block linkage is read out from the memory 13 based on the address adr1 and the linkage block count. The decoding section 104 carries out the entropy decoding such that the DC component DC00 is separated. Since the block (0, 0) is the rearrangement start position, the reconfiguring section 106 calculates the differential DC value DC00 based on the DC value DC00 of the configuration data and the held DC value “0”. The calculated differential DC value is set in place of the original differential DC value of the decoded block, and then the block is entropy-encoded to be outputted to the memory 13.

Since the linkage block count is three, the block (1, 0) to be linked next is read out from the memory 13. At this time, an address at the time of storage of the original blocks is used. Since the compression order of the blocks has been not changed, the DC component of the block (1, 0) is also not changed. The DC value of the block (1, 0) is calculated. When the differential DC component is (DC10-DC00), and the held DC value is DC00, the DC value of the currently processed block (1, 0) is calculated as DC10. The DC value DC10 is held as the new DC value. The block (1, 0) of the image data in the frequency space is entropy-encoded in continuation from the block (0, 0) and the entropy-encoded image data is outputted to the memory 13 through the input and output control section 101. In this case, the block data D(0, 0) and D(1, 0) have the same data as the original data even after the reconfiguring process. When the process advances to the block (2, 0) in this way, the DC value DC20 is held as the new DC value after completing the processing of the block (2, 0) as described above. Here, the processing has been completed for the linkage block count “3”.

The reconfiguring section 106 reads out the configuration data of the next rearrangement order 2 (DC value DC01, and address adr2). For this purpose, the reconfiguring section 106 instructs to read out the block (0, 1) of the compressed image data from the memory 13 based on the address adr2. The DC value of the read-out block is (DC01-DC80). The DC value (DC01) can be obtained from the configuration data, and then the differential DC value (DC01-DC20) is then calculated based on the DC value DC01 and the held DC value Dc20. The block (0, 1) of the image data in the frequency space is entropy-encoded in continuation from the block (2, 0) of the image data in the frequency space, and the entropy-encoded image data is outputted to the memory 13 through the input and output control section based on the adr2. Thus, the calculated differential DC value (DC01-DC20) is stored in place of the original differential DC value (DC01-DC80) of the read-out block.

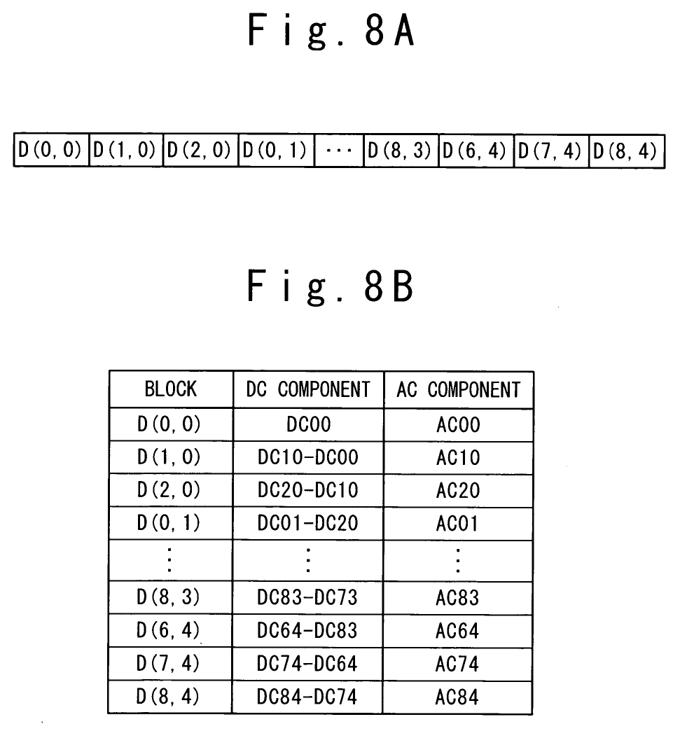

FIGS. 8A and 8B show a data stream and a conceptual table of a stream data after the rearrangement. The arrangement of the blocks of the image data is changed, and the differential DC value of the block in each rearrangement start position is different from that in FIG. 7B. For example, the DC value of the block data D(0, 1) in FIG. 8B is (DC01-DC20), while the DC value of the block data D(0, 1) is (DC01-DC80) in the original image data. Thus, a newly compressed image data in which the blocks are rearranged can be generated without expansion of the image data into the real space, by decoding the original compressed image data into the image data in the frequency space, changing the differential DC values based on the configuration data and the held DC value, and carrying out the entropy encoding on the rearranged blocks.

### Second Embodiment

The image compression apparatus according to the second embodiment of the present invention will be described. In the second embodiment, a memory to be used is further reduced. The configuration of image processing apparatus is the same as that in the first embodiment. In the first embodiment, the recompressing process is carried out after extraction of the configuration data is entirely completed. However, the configuration data of each block to which the recompressing (encoding) process is completed is unnecessary. Therefore, in the second embodiment, all the configuration data are not extracted prior to the compression, and the configuration data that is no longer necessary is overwritten. The configuration data of one group in which the blocks having the same X coordinate are contained, are firstly extracted, and then the configuration data of the next group are extracted while the blocks of the former group are recompressed, and then overwritten on the former configuration data. As a result, it is possible to reduce a storage area of the data storage section 105 for the configuration data.

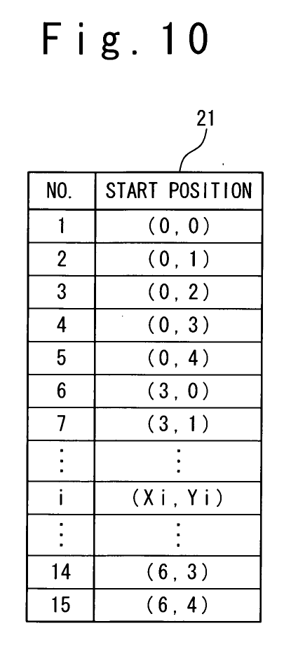

The reconfiguration setting data is set in the position setting section 102. In the reconfiguration setting data, the head block of each block linkage is indicated as the rearrangement start position 21, as shown in FIG. 10. Here, the linkage block count is all three. Therefore, it is not necessary to hold the linkage block count with respect to the rearrangement order, as a part of the reconfiguration setting data. Also, since the extracting process and the recompressing process are carried out in horizontal direction, the configuration data for one group are stored or held in the data storage section 105.

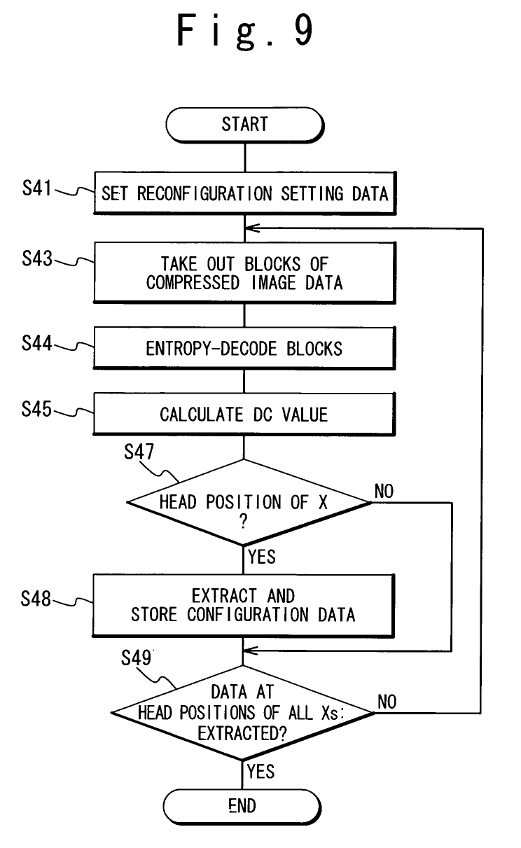

An operation of the image processing apparatus in the second embodiment will be described with reference to the attached drawings. FIG. 9 is a flow chart showing an operation of extracting the configuration data. The extracting process of the configuration data is started by setting the rearrangement start positions 21 indicating the positions of the head blocks of the block linkages, to the position setting section 102, as shown in FIG. 10. The rearrangement start positions 21 are instructed from the CPU 12 in accordance with the rearrangement order, to be set in the position setting section 102. Additionally, the linkage block count “3” is set for every rearrangement order. The linkage block count indicates the number of blocks continuously processed from the rearrangement start position in the horizontal direction. The X-coordinate of the rearrangement start positions of the rearrangement orders 1 to 5 are “0”, and these blocks are grouped (Step S41).

The blocks of the compressed image data are read out in order shown in FIG. 2A from the memory 13 through the input and output control section 101 (Step S43). The read-out blocks of the compressed image data are sequentially decoded into the block of an image data in a frequency space by the entropy decoding section 104, and each block of the image data in the frequency space is sent to the data extracting section 103 (Step S44). The data extracting section 103 extracts a DC component from each block of the image data in the frequency space. The DC component is stored as a differential DC value between a DC value of a currently processed block and a DC value of a previously processed block. Therefore, the DC value of the currently processed block is calculated based on the differential DC value of the currently processed block and the DC value of the previously processed block. At this time, the DC value of the previously processed block is held in the data extracting section 103. An initial value of the held DC value is “0” (Step S45). Next, it is determined whether or not the currently processed block is a block in an rearrangement start position in a group, namely the currently processed block has the x-coordinate of “0” (Step S47). If the block is not in the rearrangement start position (Step S47—NO), the processing of the next block is followed without storing the configuration data. If the block is in the head position of the block linkage (Step S47—YES), the calculated DC value is stored in the data extracting section 103 in place of the existing DC value for processing of the next block.

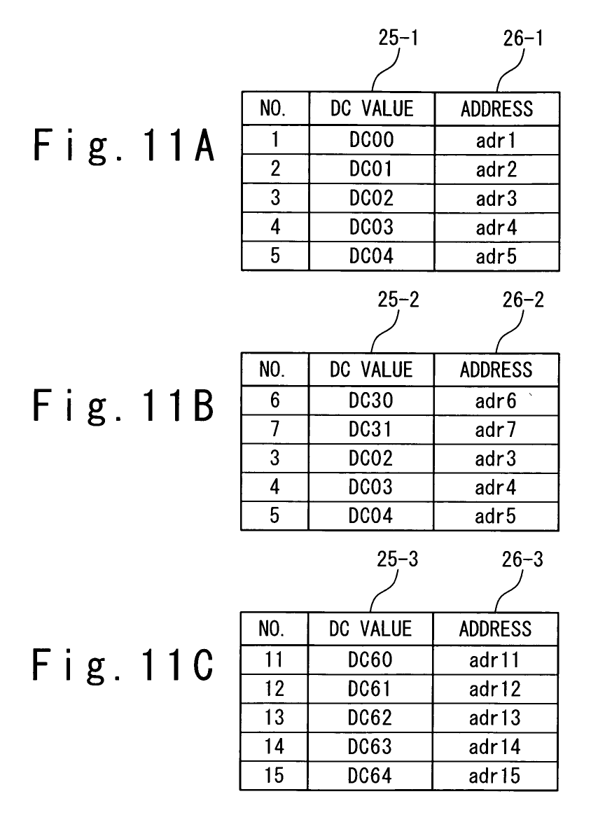

As the data necessary for the rearrangement of the currently processed block, the data extracting section 103 extracts the DC value of the currently processed block, and an address of the currently processed block in the memory 13. Since the blocks of the compressed image data are variable-length data, the address of the memory 13 may indicate a byte (word) position, or a bit position. The calculated DC value and address are outputted to the data storage section 105. The data storage section 105 stores the DC value 25-1 and the address 26-1 in accordance with the rearrangement order, as shown in FIG. 11A (Step S48).

Next, it is determined whether or not all the configuration data of the head blocks of the block linkages are extracted (Step S49). If any block to be extracted is left (Step S49—NO), the above extracting process is repeated by returning to Step S43. If the configuration data are extracted to be stored in the data storage section 105 for all the blocks of the rearrangement start positions having the x-coordinate of “0” (Step S49—YES), the extracting process is completed. Thus, the configuration data are obtained as shown in FIGS. 11A to 11C.

For example, it is supposed that the compressed image data in FIG. 2A is inputted, and the rearrangement of the image data is carried out in the same way as in case of the first embodiment. If the above extracting process is completed, sets of five DC values 25-1 and five addresses 26-1 are first extracted as shown in FIG. 11A.

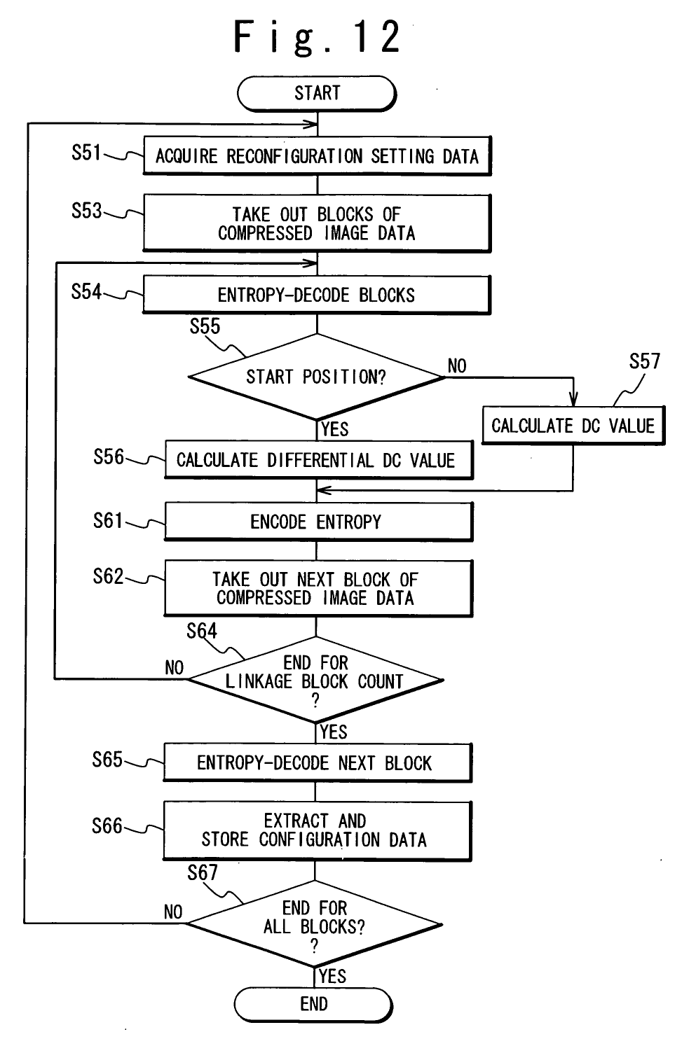

An operation of the recompressing process will be described with reference to FIG. 12. When this processing is started, the extracted configuration data is registered as shown in FIG. 11A. Also, a held DC value (operation domain) is cleared, as an initial setting process not shown.

The reconfiguring section 106 reads out five sets of configuration data in order from the data storage section 105 (Step S51). Based on the obtained address 26-1, the image compressing unit 11 reads out the compressed image data from the memory 13 through the input and output control section 101 (Step S53). The read-out block is entropy-decoded into a block of the image data in a frequency space by the entropy decoding section 104, and the block of the image data is outputted to the reconfiguring section 106 (Step S54). The reconfiguring section 106 determines whether or not a currently processed block is a block in the rearrangement start position (Step S55). If the currently processed block is a block in the rearrangement start position (Step S55—YES), a differential DC value of the currently processed block is calculated based on the DC value 25-1 of the obtained configuration data and the held DC value (DC value of the previously processed block). The calculated DC value is held for processing of the next block (Step S56). If the currently processed block is not a block in the rearrangement start position (Step S55—NO), the block is for linkage, and the differential DC value can be used without change. For calculation of a differential DC value of the next block, the DC value of the currently processed block is calculated based on the differential DC value and the held DC value, and the calculated DC value is held as a new DC value for the next block (Step S57).

When the differential DC value of the currently processed block is calculated in the Step S56 or the DC value is calculated in the Step S57, the entropy encoding section 107 entropy-encodes the currently processed block of the image data in the frequency space subsequently to the previously processed block. The encoded block is outputted as the block of the reconfigured compressed image data to the memory 13 through the input and output control section (Step S61). Then, the block of the compressed image data to be processed next is read out from a next address (Step S62). The processing from the Steps S54 to S62 is repeated to the blocks for the linkage block count (Step S64—NO). If the processing for the linkage block count CONi (3 is set to every linkage block count here) is completed (Step S64—YES), the extracting process for a next group is carried out.

Since the last block of the compressed image data in one block linkage has already been read out in at the Step S62, the entropy decoding section 104 entropy-decodes the head block in the next block linkage in the horizontal direction (Step S65). The block of the compressed image data is converted into the block of the image data in a frequency space, and a differential DC value and an address of the memory 13 of the currently processed block are extracted. A DC value of the currently processed block is calculated based on the extracted differential DC value and the held DC value. The address and DC value are stored in the data storage section 105 at a position corresponding to the rearrangement order of the configuration data. For example, the address and DC value are stored in the data storage section 105 in place of the DC value DC00 and the address adr1. Therefore, the DC value and the address are overwritten (Step S66). However, the calculated DC value is not held for a next block. Therefore, the DC value of the last block in the block linkage remains held.

Next, it is determined whether or not the recompression of all the blocks is completed (Step S67). If any block to be recompressed is left (Step S67—NO), the process is repeated back from Step S51 of obtaining the configuration data. If the recompression of all the blocks is completed, the recompressing process is ended (Step S67—YES).

For example, the rearrangement start position is set as shown in FIG. 10, and the configuration data is extracted as shown in FIG. 11A. First of all, the held DC value (operation domain) is cleared. The address adr1 is read out as the address 26-1 of the configuration data corresponding to the rearrangement order 1, and the block of the compressed image data is read out from the memory 13 based on the address adr1 and is entropy-decoded. Since the processing at this time is the processing of the rearrangement position, a differential DC value DC00 is calculated from the DC value DC00 of the configuration data and the held DC value “0”. The DC value DC00 of the currently processed block is held as a new DC value for a next block. The calculated differential DC value DC00 is set in places of the DC value DC00 of the decoded block (if the value remains unchanged in the origin block, and the original image data may be used), and the block after the rearrangement is generated. The generated image data is entropy-encoded to be stored in the memory 13.

As the next block of the compressed image data (block linkage number is 2), a data in continuation from the data of the previously processed block is read out from the memory 13. Since the head block has been just processed, processing of the next block to be linked is carried out such that the entropy-decoding is carried out at the Step S54. As the processing of the block to be linked, a DC component is extracted from a decoded block of the image data in the frequency space, and a DC value DC10 of the currently processed block is calculated based on the differential DC value (DC10-DC00) and the held DC value DC00. The calculated DC value DC10 is held as a new DC value for a next block. Since the differential DC value of the decoded block of the image data can be used without change, the block is generated such that the currently processed block continues the previously processed block. The entropy encoding section 107 carries out the entropy encoding for storage in the memory 13.

The next block of the compressed image data (block linkage number is 3) is read out from the memory 13, and the block read out from the memory 13 is processed in the same way, to be stored in the memory 13. The next block of the compressed image data is read out, when the processing for the linkage block count is completed, and the held DC value is DC20. Therefore, extraction of the configuration data for the next block linkage is carried out. That is, a DC component and an address are extracted at the Step S66 from the image data in the frequency space entropy-decoded at the Step S65. The extracted DC component is a differential DC value (DC30-DC20), and the DC value DC30 is calculated based on the held DC value DC20. The DC value DC30 and the address adr6 are stored in the data storage section 105. This position is read as being in the order number 6 next time.

If the processing of the block linkages of the order numbers 1 and 2 are completed in this way, the data storage section 105 has the DC value 25-2 and an address 26-2 that are rewritten in sequence, as shown in FIG. 11B. The data of the positions of the rearrangement order 1 and 2 for which the processing has been completed, are overwritten on data of the rearrangement order 6 and 7, data of the rearrangement order 3, 4, and 5 where the processing is not yet carried out, are left without change. Further, when the processing is advanced to carry out the recompressing process of the last line, a DC value 25-3 and an address 26-3 keep the configuration data of the last line, as shown in FIG. 11C. In other words, data of the rearrangement order 11 to 15 are extracted.

In this way, it is possible to further reduce the storage area of the configuration data by overwriting configuration data that is no longer necessary, without extracting all the configuration data prior to the compression.

The reconfigured blocks of the compressed image data are read out based on the reconfiguration setting data by the CPU 12 and outputted as a data stream.

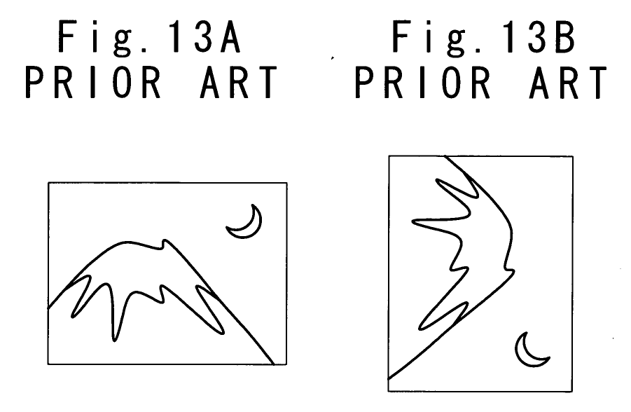

The compressed image data recompressed in this way can be expanded as shown in FIG. 2C, in the order of large block areas 31, 32, and 33 having x-coordinates 0 to 2, 3 to 5, and 6 to 8 respectively, where the X-axis and the Y-axis are switched, and the direction of the switched Y-axis is turned into the opposite direction. Therefore, the present invention is especially effective when a scene photographed as shown in FIG. 13A is printed on a sheet of vertically-long paper as shown in FIG. 13B.

In the above embodiments, the width of the block linkages of the rearranged compressed image data is set to be three blocks. However, when a printer is an ink jet printer for example, the block linkage width may be determined in accordance with the number of nozzles, since the number of pixels capable of being printed each time a print head is scanned once, is related to the number of nozzles provided to the print head.

Also, since the linkage block count can be set for each of the blocks, it is not necessary to carry out image processing after all the image data is expanded, when a data as part of an image is taken out or trimmed. Consequently, reduction in the memory capacity required for expansion is possible.

In this way, a compressed image data is rearranged in units of blocks of 8×8 pixels in accordance with the configuration of an image to be ultimately obtained, without expanding all the compressed image data on an image space. Therefore, according to the present invention, when an image data taken out with one apparatus is transferred to another apparatus, and the configuration of the image is processed, it is possible to process the image only by providing memories of a minimal capacity in the both of the apparatuses.

Further, the above embodiments has been described in case that the compressed image data is rearranged when sending the compressed image data from a digital camera to a printer. However, this processing may also be carried out as preprocessing of printing in the printer.

### Third Embodiment

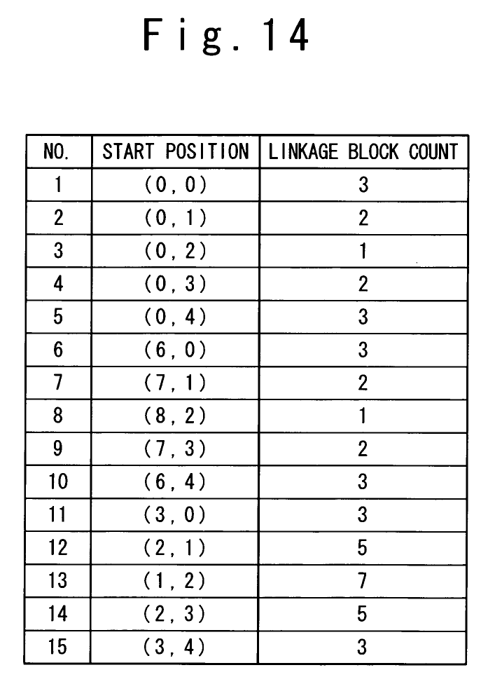

The image compression apparatus according to the third embodiment of the present invention will be described. In the third embodiment, the linkage block count of block linkages is not constant. The configuration of the image compression apparatus in the third embodiment is the same as that in the first embodiment. Since the linkage block count is not constant, the reconfiguration setting data has the rearrangement start position (X, Y) of the block linkages and the linkage block count, as shown in FIG. 14.

The x-coordinate of the rearrangement start position of the order numbers 1 to 5 is “0”, indicating that the order numbers 1 to 5 are relevant to a left-side part of an image. The linkage block count is in a range of 1 to 3, as the block linkage is not in a stripe shape, unlike the first and second embodiments. The order numbers 6 to 10 are relevant to a right-side part of the image, and the order numbers 11 to 15 are relevant to a central part of the image. Based on this reconfiguration setting data, the compressed image data is rearranged. The rearrangement of the compressed image data is carried out by extracting the configuration data from an image block in the rearrangement position, and recompressing an image data based on the configuration data, as described above.

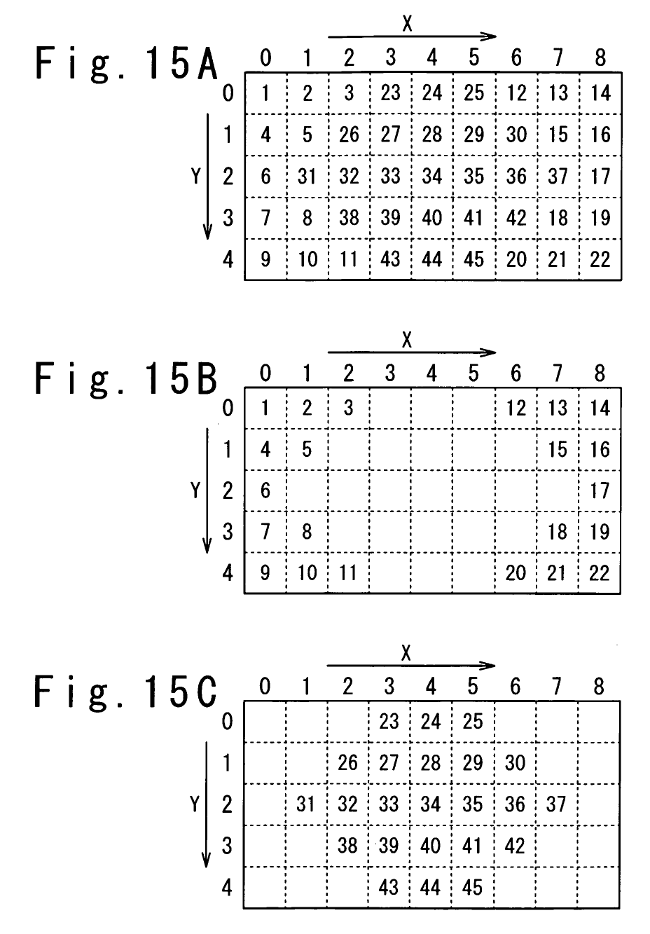

If the rearranging process is performed by using the reconfiguration setting data shown in FIG. 14, an compressed image data is rearranged in the order shown in FIG. 15A. That is, the compressed image data in the left-side part of the image is arranged first, the data of the right-side part is next, and the data of the central part is lastly arranged.

If the compressed image data is rearranged in this way, the left and right side parts of the image can be obtained as shown in FIG. 15B by expanding the compressed image data of the blocks 1 to 22. The compressed image data from the block 23 is expanded only to the image of the central part as shown in FIG. 15C. In other words, it is possible to easily generate an intended partial image without expanding all the compressed image data to the original image data.

As stated above, it is possible to generate a compressed image data that can be expanded in an order convenient for an image data device receiving the data, by rearranging the compression order of the compressed image data in a frequency space.

Additionally, according to the present invention, the input and output control section 101 is configured to carry out the input and output of a data. Alternatively, data processing may be carried out with the use of a pipeline configuration, by connecting the input and the output with separate data lines. In addition, the image compression method of the present invention is not limited to the JPEG encoding method.

According to the present invention, a memory for temporarily storing an image block of one frame is unnecessary, making it possible to reduce a memory capacity to be incorporated into a device.

Also, according to the present invention, circuits for inverse quantization and IDCT transform are unnecessary in recompressing an image data. As a result, processing time can be reduced.

Further, according to the present invention, image processing is reduced even if the image processing is performed by using software.

What is claimed is:

1. An image processing apparatus comprising:
an entropy decoding section configured to carry out entropy-decoding on each of blocks of an image data supplied thereto to generate entropy-decoded blocks;
an extracting section configured to extract original block data of said entropy-decoded blocks;
a reconfiguring section configured to relate said original block data of said entropy-decoded blocks one after another based on a reconfiguration setting data to rearrange said entropy-decoded blocks; and
an entropy encoding section configured to carry out entropy-encoding to said rearranged entropy-decoded blocks.

2. The image processing apparatus according to 1, wherein said image data is a JPEG data generated by converting an image into said image data in a frequency space in units of blocks, each of which has a plurality of pixels of the image in matrix, and carrying the entropy-encoding on said image data in unit of said blocks.

3. The image processing apparatus according to 2, wherein said image data is further quantized.

4. The image processing apparatus according to 1, wherein said blocks are grouped into a plurality of block linkages, and
said reconfiguring section rearranges said entropy-decoded blocks in units of block linkages.

5. The image processing apparatus according to 4, wherein the number of said blocks is constant over said plurality of block linkages.

6. The image processing apparatus according to 4, wherein each of said plurality of block linkages contains said blocks of an optional number.

7. The image processing apparatus according to 4, further comprising:
a reconfiguration setting data generating section configured to generate said reconfiguration setting data based on a predetermined region.

8. The image processing apparatus according to 7, wherein said entropy-encoded blocks are outputted in order based on said reconfiguration setting data.

9. The image processing apparatus according to 4, wherein said extracting section extracts said original block data of said entropy-decoded blocks and an address of a head block of each of said plurality of block linkages based on said reconfiguration setting data to produce a configuration data.

10. The image processing apparatus according to 9, wherein said reconfiguring section reads out said blocks in order based on said reconfiguration setting data to entropy-decoding said blocks, and relates said original block data of said entropy-decoded blocks based on said configuration data and said reconfiguration setting data to rearrange said entropy-decoded blocks.

11. A method of image processing, comprising:
extracting an original block data from each of blocks of an image data, wherein said original block data of said blocks which are entropy-decoded are related to one after another in an arrangement order of said blocks;
rearranging said blocks in a rearrangement order defined based on said reconfiguration setting data by relating said original block data of said blocks, which are entropy-decoded, one after another by using said original block data; and
entropy-encoding said blocks which are entropy-decoded, for a new image data.

12. The method according to 11, wherein said blocks of said image data are grouped into a plurality of block linkages while said original arrangement order is kept in each of said plurality of block linkages, and
said reconfiguration setting data contains said rearrangement order in units of block linkages and has a data indicating a head block of each of said plurality of block linkages.

13. The method according to 12, wherein said extracting comprises:
entropy-decoding said blocks in said arrangement order;
determining said original block data of said entropy-decoded blocks from a related block data of each of said entropy-decoded blocks and said original block data of a previous entropy-decoded block; and
holding said original block data of said head blocks based on said reconfiguration setting data.

14. The method according to 12, wherein the number of said blocks is constant over said plurality of block linkages.

15. The method according to 12, wherein each of said plurality of block linkages contains said blocks of an optional number.

16. The method according to 12, further comprising:
generating said reconfiguration setting data based on designation of a predetermined region.

17. The method according to 11, wherein said entropy-encoded blocks are outputted in said rearrangement order based on said reconfiguration setting data.

18. The method according to 12, wherein said plurality of block linkages are grouped into groups,
said extracting is carried out to a first one of said groups,
said rearranging comprises:
entropy-decoding said blocks in said rearrangement order, and
said method further comprises:
extracting said original block data of said head blocks of said block linkages in a next one of said group.

19. The method according to 12, wherein said rearranging comprises:
entropy-decoding said blocks in said rearrangement order; and
determining a new related block data of each of said head blocks from said original block data of said head block and said original block data of a previous block.

20. The method according to 12, wherein said blocks are stored in a memory, and said block is a variable length data,
said extracting comprised:
extracting an address of each of said head blocks in addition to said original block data thereof,
said method further comprises:
storing said entropy-encoded head block in said memory based on said address.
